(19) United States
(12) Patent Application Publication
(10) Pub. No.: US 2006/0213014 A1
(43) Pub. Date: Sep. 28, 2006

(54) Multipurpose tool

(76) Inventor: David R. Manske, Poplar Grove, IL (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 11/091,043

(22) Filed: Mar. 28, 2005

(51) Int. Cl. B25D 1/04; B25B 15/00

(52) U.S. Cl. 7/165; 7/143

(57) ABSTRACT

A multi-purpose tool that functions as a linear hammer and as a screwdriver. The tool has a handle which defines a passageway therethrough. A guide tube extends through the channel and a rod is positioned in the guide tube. A spring surrounds the guide tube within the channel and a depth adjuster is attached to a first end of the rod. A bushing encircles the guide tube adjacent an end of the handle distal from the depth adjuster, thereby securing the guide tube within the handle.

### FIELD OF THE INVENTION

This invention pertains to tool, in particular, a linear striking device or hammer that can be converted to a screwdriver.

### BACKGROUND OF THE INVENTION

Hammers and other devices for driving nails into a work surface are well known in the art. Most of these devices are of the claw hammer variety, or some variation thereof, which uses a hammer head attached to a handle. These types of hammers may include another functional implement, such as a claw for removing nails, at the opposite end of the striking surface.

The most commonly used hammers are attached to a handle that extends approximately 90° from the head of the hammer. This arrangement allows the user to generate a striking force by swinging the hammer up and down or back and forth in relation to the work surface that is being struck. The need to swing the conventional hammer back and forth can, however, become problematic if the work surface presents little or no room in which to move the hammer, thereby preventing the user from generating a striking force.

In order to overcome this problem, linear hammers have been developed in which a rod is moved within a guide tube so as to generate a linear striking force against a nail. An implement of this type is disclosed, for example, in U.S. Pat. No. 2,587,944 (Williams) and U.S. Pat. No. 3,979,040 (Denin). A shortcoming of these types of nail drivers, however, is that the striking rod may be pulled out of the guide tube during use in an attempt to generate more force. Furthermore, the user may be required to repeatedly retract and advance the rod in order to drive the nail the required depth into the work surface. This repetitive action can cause fatigue and quite possibly injury to the user. Additionally, these types of nail drivers require the use of two hands, one to position and steady the guide tube and one to operate the striking rod. This can at times be cumbersome and awkward depending on the size of the area in which one is working.

U.S. Pat. No. 5,875,950 (Nuss et al.) discloses an attempt to overcome the problem of having the striking rod separate from the guide tube. This is done by utilizing a weight in the handle in which the guide tube is seated. This, of course, results in a heavy hammer that results in greater fatigue to the user.

It is for these reasons that a linear hammer that could allow one to single-handedly drive nails into a work surface would be an important improvement in the art. Furthermore, a device that could be converted to a screwdriver and still allow for the application of a force to set a screw into a work surface prior to initiating a screwing force would also be an important improvement in the art.

### BRIEF SUMMARY OF THE INVENTION

The invention is directed to a tool comprised of a handle which defines a passageway therethrough, a guide tube that extends through the channel, a rod positioned in the guide tube, a spring surrounding the guide tube within the channel, a depth adjuster attached to a first end of the rod and secured to the handle, and a bushing encircling the guide tube adjacent an end of the handle distal from the depth adjuster.

### BRIEF DESCRIPTION OF THE DRAWINGS

FIG. 1 is a front view of the tool.

FIG. 2 is a sectional view of the tool shown in FIG. 1.

FIG. 2a is a sectional view of the tool shown in FIG. 1.

FIG. 3 is a front view of the tool showing the action of the handle required to drive a nail into a work surface.

FIG. 4 is a partial exploded view of the guide tube showing how the rod transits the guide tube to impact the nail.

FIG. 5 is a front view of the tool showing how the handle is rotated in the screwdriver embodiment.

FIG. 6 is a partial exploded view of the guide tube showing the positioning of the rod in the guide tube in the screwdriver embodiment.

FIG. 7 is sectional view of the tool showing the rod positioned in the handle.

FIG. 8 is a front view of the depth adjuster showing a padded grip around the outside of the adjuster.

FIG. 9 is a sectional view of an embodiment of the depth adjuster showing the screwdriver rod positioned therein.

FIG. 10 is a front view of a Phillips-head screwdriver rod.

FIG. 11 is a front view of a standard-head screwdriver rod.

FIG. 12 is a side view of an extension rod accessory for the tool.

FIG. 13 is a side view of an angle guide accessory for the tool.

FIG. 14 is a perspective view of a spacer accessory for the tool.

FIG. 15A is a side view of the tool showing an embodiment of a light source accessory.

FIG. 15B is a side view of the tool showing an embodiment of a light source accessory.

FIG. 15C is a side view of the tool showing an embodiment of a light source accessory.

### DETAILED DESCRIPTION OF THE INVENTION

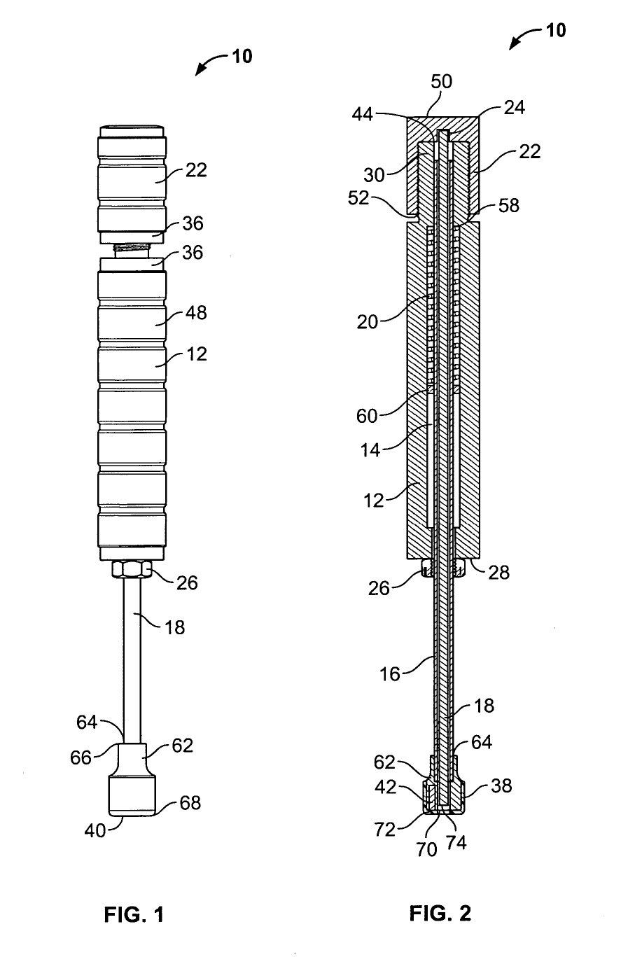

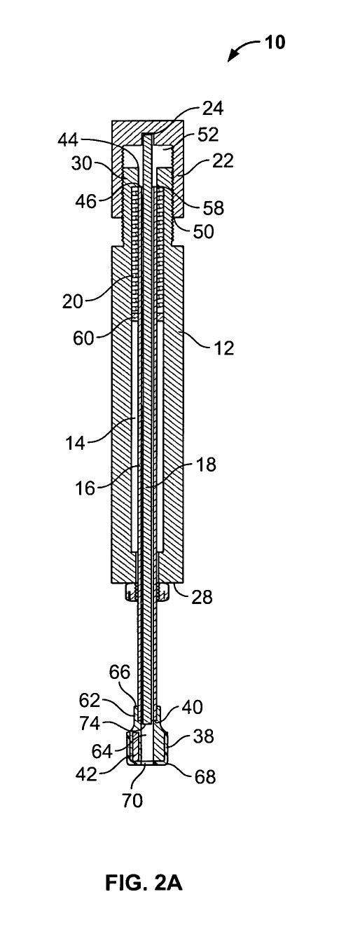

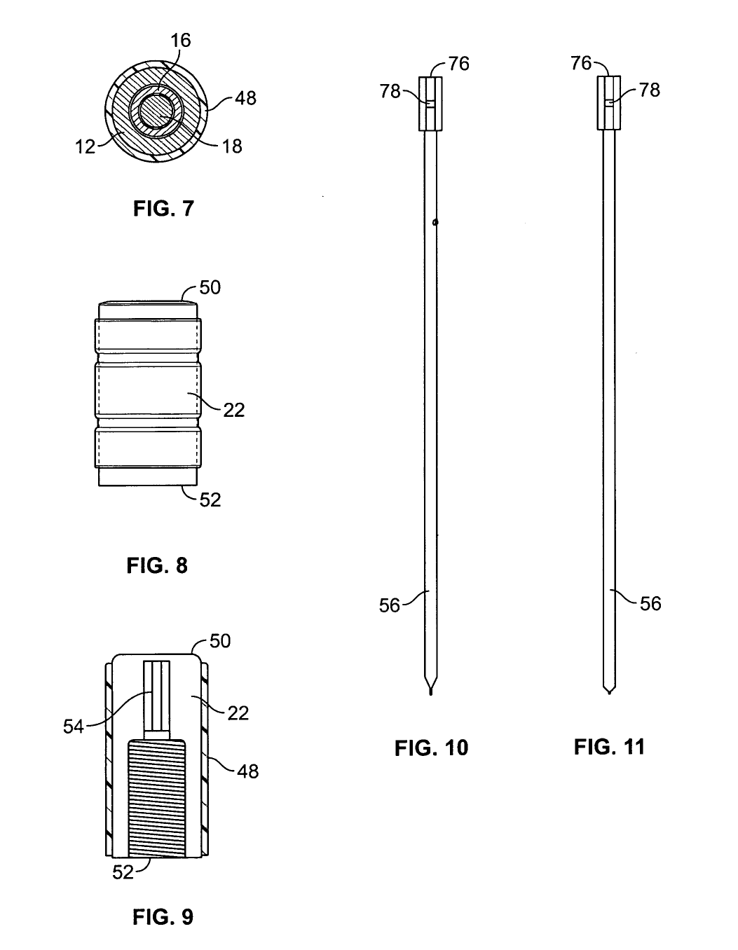

As shown in FIGS. 1-11, the invention involves a multi-purpose tool 10 that functions as a linear hammer and as a screwdriver. FIGS. 1, 2 and 2a show the tool 10 which is comprised of a handle 12 which defines a channel 14 therethrough. A guide tube 16 extends through the channel 14 and a rod 18 is positioned in the guide tube 16. A spring 20 surrounds the guide tube 16 within the channel 14 and a depth adjuster 22 is connected to a first end 24 of the rod 18 and is attached to the handle 12. A bushing 26 encircles the guide tube 16 adjacent an end 28 of the handle 12 distal from the depth adjuster 22, thereby securing the guide tube 16 within the handle 12.

In an embodiment, the handle 12 has a threaded first end 30 and the depth adjuster 22 is screwed to the first end 30 of the handle 12. This allows for a more accurate adjustment of the rod 18 in order to predetermine the depth at which a nail 32 will be driven into a work surface 34. The depth adjuster 22 may also include indicia 36, as shown in FIGS. 1, 3 and 5, that identifies a depth the rod 18 will drive a nail 32 into a work surface 34. A protective tip 38 may also be attached to an end 40 of the guide tube 16 distal to the depth adjuster 22, and at least one magnet 42 may be positioned adjacent to the protective tip 38, as shown in FIGS. 2, 4 and 6.

The protective tip 38 may be made of any suitable material including rubber. In an embodiment, the handle 12 may have a tapered second end.

The assembly of the tool 10 will now be described. The following example further illustrates the invention but, of course, should not be construed as in any way limiting its scope. It is important to note that the sizes and measurements cited in this example are exemplary only and are not limiting in any way on the spirit and scope of the invention.

Any suitable material including, but not limited to, steel may be used to manufacture the tool 10. In one embodiment, the handle 12 may be made of steel and be approximately 8½″ long and 1 and 3/16″ in diameter. The second end 28 of the handle 12 has an opening center drilled ½″ diameter by 7½″ deep, with the first ½″ of the opening threaded. The first end 30 of the handle 12 is turned down to a ¾″ outside diameter by 1½″ deep and has sixteen threads per inch. A 3/16″ opening 44 is center drilled in the first end 30. This opening 44 continues into the ½″ diameter opening 46 inside the handle 12, thereby defining the channel 14 that extends through the handle 12. In a particular version of the embodiment, the handle 12 may be covered by a protective grip 48, as shown in FIGS. 1, 3, 5 and 7-9.

The depth adjuster 22 may be made of steel two inches long by 1 3/16 inch in diameter. A first end 50 of the depth adjuster 22 has an opening 52 center drilled at two diameters. The opening 52 is first center drilled ¾″ diameter by 1⅝″ deep and is threaded the full depth with sixteen threads per inch. The opening 52 is then center drilled at the bottom of the first center drill at 3/16″ diameter by ¼″ deep. The rod 18, which may be of 3/16″ diameter solid steel, has one end hardened and a second end pressed into the 3/16″ diameter opening of the depth adjuster 22. In addition to being hardened, the one end of the rod 18 may be textured so as to prevent the nail from moving toward the guide tube. The depth adjuster's internal ¾″ threads are then screwed onto the ¾″ external threads of the handle 12. Indicia marks 36 may be included on the depth adjuster 22 and the handle 12. These marks 36 may be two small round indentations of contrasting color, one on the handle 12 and one on the depth adjuster 22, as shown in FIG. 1.

In another embodiment, as shown in FIG. 9, after first center drilling and threading the ¾″ diameter by 1⅝″ deep opening 52, the opening 52 is then center drilled at the bottom at 5/16″ diameter by 1″ deep. A 5/16″ outside diameter, female hex or octagon insert 54 is then pressed into the opening 52, as shown in FIG. 9. The female insert 54 accepts various screwdriver inserts 56, 58, such as those shown in FIGS. 10 and 11.

The guide tube 16 may be made of stainless steel and may be 11″ long by 5/16″ outside diameter and 3/16″ inside diameter. One end 58 of the guide tube 16 is inserted into the second end 28 of the handle 12 where it encircles the rod 18 and is encircled by at least one spring 20. The spring 20, which may be a 7½″ long compression spring, for example, slides over the guide tube 16 up against a spring retainer 60. The guide tube 16 is held in place by a bushing 26 attached to the second end 28 of the handle 12. This bushing 26, which holds the tool 10 together as one piece, may be a standard 5/16″ brake line fitting with ½″ external threads on one end and 1/2″ hex nut on the other. When positioned over the guide tube 16, the hex nut is adjacent the second end 28 of the handle 12. In an embodiment, the bushing 26 may be used to secure the guide tube 16 in a retracted position.

In one embodiment, a bell shaped finger grip 62 may extend form the end 40 of the guide tube 16 distal to the handle 12. This finger grip 62 may be made of aluminum and include a 5/16″ opening 64 in the one end 66 in which the guide tube 16 is pressed and two 3/16″ openings 70, 72 in the opposite end 68. As shown in FIG. 2, one of these openings 70 is centered and passes completely through the finger grip 62 while the second opening 72 is offset and drilled ¼″ deep for a magnet 42 to be pressed in. A no-mar pad made of material such as a hard rubber washer may be attached to the end of the finger grip.

FIG. 11 shows another embodiment of the invention in which the rod 18 has a second end 74 in the shape of a standard screwdriver and a first end 24 capable of attachment to the depth adjuster 22. In another embodiment, the second end 74 of the rod 18 may be in the shape of a Philips-head screwdriver, as shown in FIG. 10. The rod 18 that forms these screwdriver inserts may be made of any suitable material, including steel. In an embodiment, the screwdriver inserts are approximately 14″ long and have a ¼″ male hex or octagon 76 at the first end 24. The first end 24 also includes a spring-loaded ball bearing retainer 78.

When in operation, the user first determines the depth at which he desires to drive the nail 32 into the work surface 34. This is done by adjusting the distance of the depth adjuster 22 from the first end 30 of the handle 12. For example, if one desires the nail 32 to be flush with the work surface 34, the depth adjuster 22 is positioned so as to contact the first end 30 of the handle 12. In order to adjust the rod 18 so that a portion of the nail 32 extends from the work surface 34, the depth adjuster 22 is positioned a respective distance from the first end 30 of the handle 12. This means that if one desires the head of the nail 32 to extend a ¼″ from the work surface 34 to allow for the hanging of, for example, a picture or a string of lights, the depth adjuster 22 would be positioned ¼″ from the first end 30 of the handle 12.

One way of obtaining a precise measurement is to incorporate a threaded micro adjuster that allows infinite depth settings from flush with the work surface 34 to approximately 1¼″. This is done, in one embodiment, by providing the adjuster with sixteen threads per inch thus resulting in a 1/16″ depth change for every 360° of revolution of the adjuster.

In such an embodiment, one 360° revolution of the depth adjuster 22 results in the head of a nail 32 being driven into a work surface 34 extending 1/16″ above the surface 34. Two 360° revolutions results in a ⅛″ protrusion, four revolution a ¼″ protrusion and eight revolutions a ½″ protrusion. The gap between the handle 12 and the depth adjuster 22 indicates the amount of nail 32 that remains protruding from the work surface 34. This gap can be observed visually, by touch, or by counting the number of 360° revolutions the depth adjuster 22 is turned.

After the operator sets the depth adjuster 22 to the desired setting, a nail 32 is inserted head first into the open end 40 of the guide tube 16 distal to the depth adjuster 22. In one embodiment, the open end 40 of the guide tube 16 is covered with a protective tip that may include a magnet 42, as is shown in FIG. 2. The magnet 42 holds the nail 32 in place while the end of the guide tube 16 is positioned against the work surface 34 so that the handle 12 is perpendicular to the surface 34.

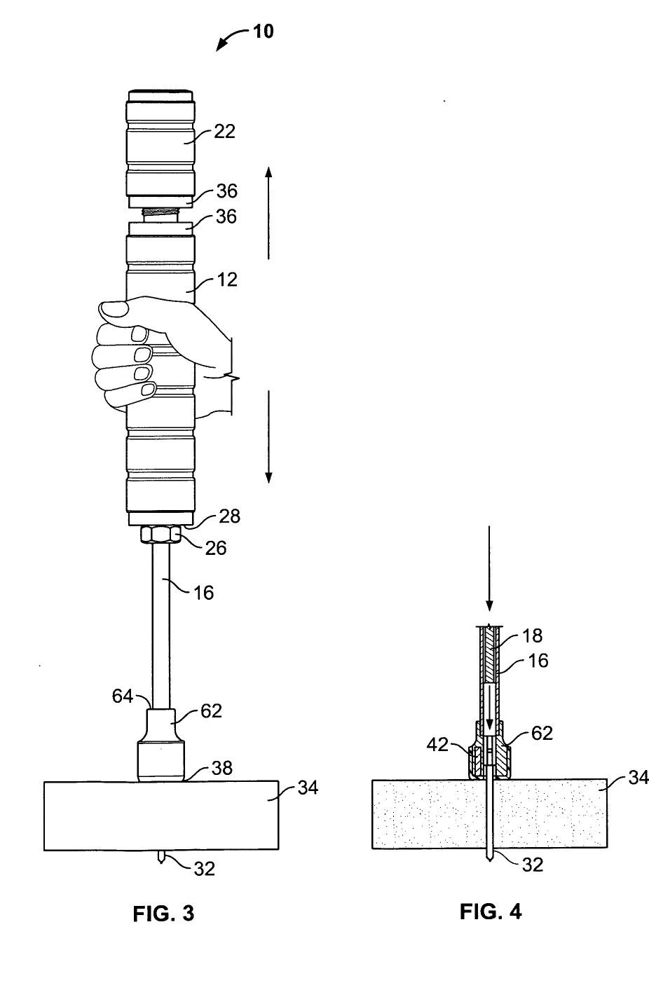

After positioning the end of the guide tube 16 against the work surface 34, the operator can then, with one hand, loosely grip the handle 12 and by using short, in-and-out strokes, drive the nail 32 into the work surface 34, as shown in FIG. 3. The nailing process will be complete when the sound of the strokes changes in tone and when the vibrations in the handle 12 change from soft and mushy to sharp and firm. The guide tube may also be marked to indicate the stroke stopping point.

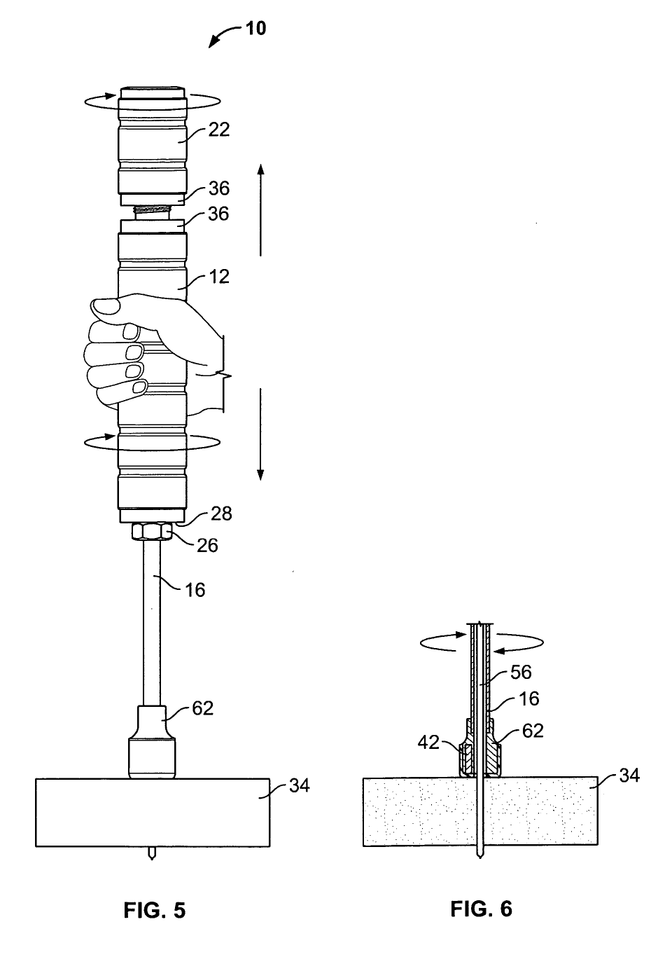

When utilizing the tool 10 as a screwdriver, the operator positions the screw in the open end 40 of the guide tube 16 where it is held in place by a magnet 42. The guide tube 16 is positioned against the work surface 34 and the handle 12 is rotated with respect to the guide tube 16, as shown in FIG. 5, thereby rotating the screwdriver insert 18 and screwing the screw into the work surface 34.

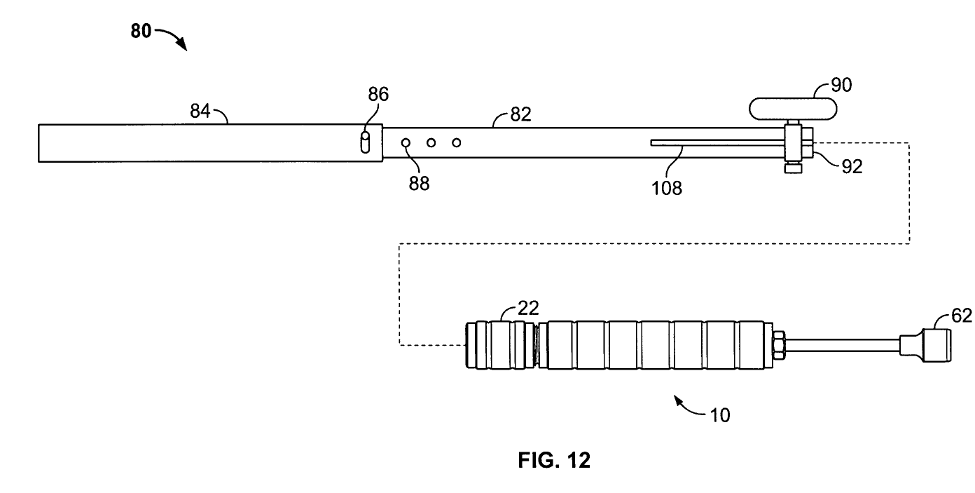

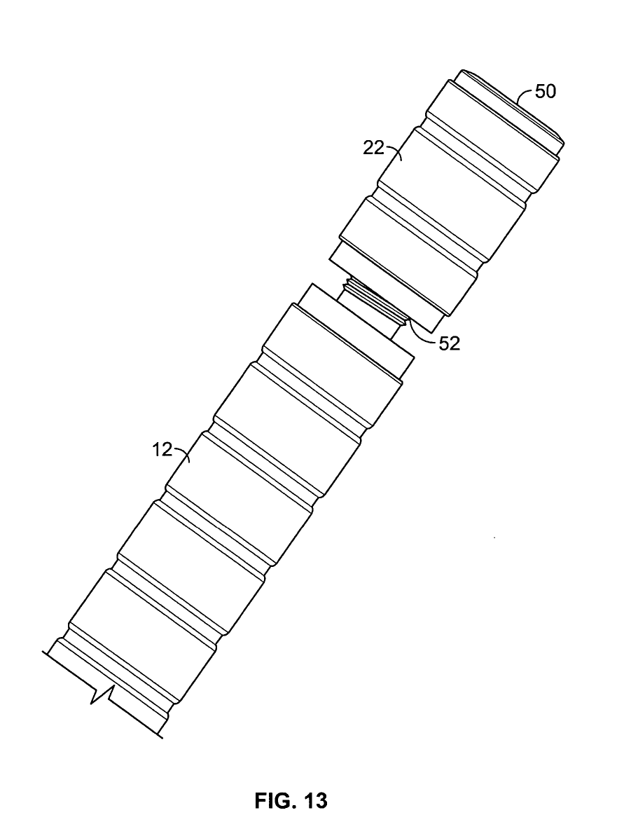

In an embodiment, the tool 10 has an extension rod 80 for remote use of the tool 10. In an embodiment, as shown in FIG. 12, the extension rod 80 is attached to the end of the tool 10 having the depth adjuster 22. In an embodiment, a first end 92 of the extension rod 80 is detachably coupled to the tool 10 with an extension rod fastener 90. A variety of fastening mechanisms are appropriate for coupling the tool 10 and the extension rod 80. In one embodiment, as shown in FIG. 12, the extension rod fastener 90 may be a tension fastener. In an embodiment, the first end 92 of the extension rod 80 may have a split 108, thereby allowing for adjustment of the size of an opening at the first end 92 of the extension rod 80. In an embodiment, the extension rod 80 may be telescopic. As shown in FIG. 12, the extension rod 80 may comprise a first section 82 and a second section 84, wherein the first section 82 of the extension rod 80 and the second section 84 of the extension rod 80 are in mechanical communication. The first section 82 of the extension rod 80 and the second section 84 of the extension rod 80 may be attached together by any suitable means. For example, a locking pin 86 and at least one locking pin receptacle 88 may be used to couple the first section 82 and the second section 84 of the extension rod 80.

In an embodiment, the finger grip 62 is capable of receiving at least one detachable tool accessory. Examples of such tool accessories will now be further described.

In an embodiment, an angle guide 94 is detachably coupled to an end 40 of the guide tube 16 distal from the depth adjuster 22. In an embodiment, the angle guide 94 snaps onto the tool 10 over the finger grip 62, as shown in FIG. 13. In an embodiment, the finger grip 62 is housed within an angle guide tube 96 when the angle guide 94 is attached to the tool 10. In an embodiment, the angle guide 94 has a non-slip grip 98, such as an enlarged non-slip pad or hand grip, as shown in FIG. 13.

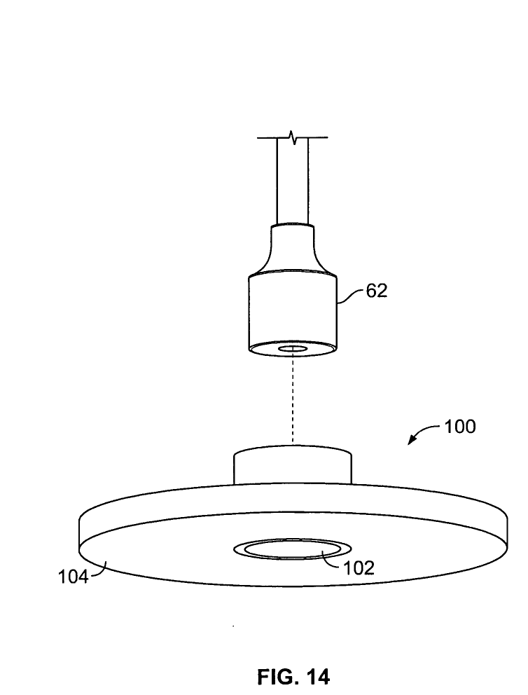

In an embodiment, the tool 10 has a spacer 100 detachably coupled to the end 40 of the guide tube 60 distal from the depth adjuster 22. In an embodiment, the spacer 100 snaps onto the tool 10 over the finger grip 62. In an embodiment, the spacer 100 defines a passage 102 through which the rod 18 of the tool 10 passes. In an embodiment, the spacer 100 maintains a substantially uniform distance between the work surface 34 and raised objects, e.g., nails 32, which are substantially perpendicular to the work surface 34. In another embodiment, the spacer 100 maintains a substantially uniform distance between an edge of a work surface 34 and an object, e.g., a nail 32, being inserted into the work surface. In an embodiment, as shown in FIG. 14, the spacer 100 has a base 104 with an annular shape. In an embodiment, the outer radius of an annular-shaped base 104 of a spacer 100 is two inches. In another embodiment, the outer radius of an annular-shaped base 104 of a spacer 100 is one inch.

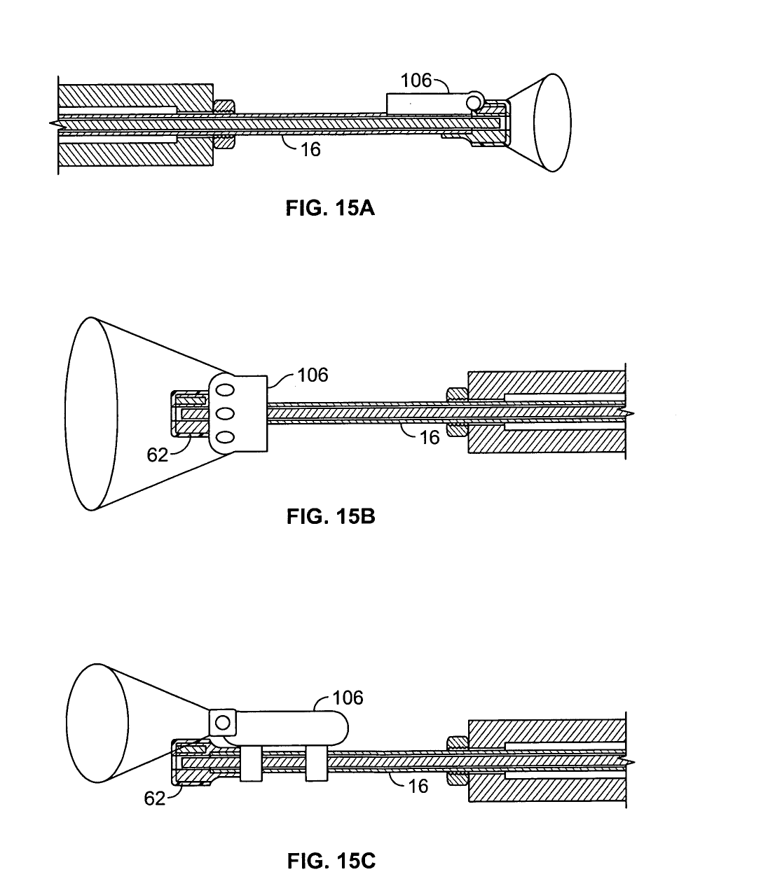

In an embodiment, the tool 10 has a light source attachment 106 for illuminating the end of the tool 10 and the work surface 34. In an embodiment, the light source 106 is coupled to the end 40 of the guide tube 60 distal from the depth adjuster 22. In an embodiment, the finger grip 62 may be clear plastic and backlit, thereby also serving as the light source 106, as shown in FIG. 15A. In an embodiment, the light source 106 is detachably coupled to the end 40 of the guide tube 60 distal from the depth adjuster 22. In an embodiment, the light source 106 snaps onto the tool 10 over the finger grip 62. In an embodiment, as shown in FIG. 15C, the light source 106 may attach to the tool 10 by clipping onto the guide tube 16. In an embodiment, the light source 106 is adjacent to the end 40 of the guide tube 60 distal from the depth adjuster 22. In another embodiment, as shown in FIG. 15B, the light source 106 may be an annular-shaped lighted collar which encircles the tool 10 over the finger grip 62 or the end of the guide tube 16 nearest the finger grip 62.

In an embodiment, the tool 10 has a centralized center of gravity, thereby resulting in a tool 10 that is balanced and easier to manipulate than other linear hammers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A tool comprised of:
a handle, the handle defining a channel therethrough;
a guide tube extending through the channel;
a rod positioned in the guide tube;
a spring surrounding the guide tube within the channel;
a depth adjuster connected to a first end of the rod and attached to the handle; and
a bushing encircling the guide tube adjacent an end of the handle distal from the depth adjuster, thereby securing the guide tube to the handle.

2. The tool of claim 1, wherein:
the handle has a threaded first end;
the depth adjuster defines a threaded opening therein; and
the depth adjuster is screwed to the first end of the handle.

3. The tool of claim 2, wherein:
the first end of the handle is threaded with sixteen threads per inch;
the opening in the depth adjuster is threaded with sixteen threads per inch; and
one revolution of the depth adjuster with respect to the handle separates the depth adjuster 1/16″ from the handle, thereby retracting an end of the rod distal to the depth adjuster 1/16″ from an end of the guide tube distal to the depth adjuster.

4. The tool of claim 1, wherein:
a protective tip is attached to an end of the guide tube distal to the depth adjuster; and
at least one magnet is positioned adjacent to the protective tip.

5. The tool of claim 4, wherein the protective tip is made of rubber.

6. The tool of claim 1, wherein the handle has a tapered second end.

7. The tool of claim 1, wherein the handle is manufactured of steel.

8. The tool of claim 1, wherein:
the rod has a second end in the shape of a standard screwdriver.

9. The tool of claim 1, wherein a second end of the rod is in the shape of a Philips-head screwdriver.

10. The tool of claim 1, wherein a second end of the rod is in a shape selected from the group consisting of a hexagon and an octagon.

11. The tool of claim 1, wherein the first end of the rod includes a spring-loaded ball bearing retainer.

12. The tool of claim 1, wherein the depth adjuster includes indicia that identify a depth the rod will drive a nail into a work surface.

13. The tool of claim 12, wherein the indicia includes a first indentation on the depth adjuster and a second indentation on the handle.

14. The tool of claim 13, wherein the first and second indentations are painted with contrasting colors.

15. The tool of claim 1, further comprising an extension rod coupled to the depth adjuster.

16. The tool of claim 15, wherein the extension rod is a telescoping extension rod.

17. The tool of claim 15, wherein the extension rod is detachably coupled to the depth adjuster.

18. The tool of claim 1, further comprising:
an angle guide detachably coupled to an end of the guide tube distal from the depth adjuster.

19. The tool of claim 18, wherein the angle guide has a non-slip grip.

20. The tool of claim 1, further comprising:
a spacer detachably coupled to an end of the guide tube distal from the depth adjuster, wherein the spacer maintains a substantially uniform distance between a work surface and raised objects which are substantially perpendicular to the work surface.

21. The tool of claim 1, further comprising:
a spacer detachably coupled to an end of the guide tube distal from the depth adjuster, wherein the spacer maintains a substantially uniform distance between an edge of a work surface and an object being inserted into the work surface.

22. The tool of claim 1, further comprising:
a light source, wherein the light source is adjacent to an end of the guide tube distal from the depth adjuster.

23. The tool of claim 22, wherein the light source is detachably coupled to an end of the guide tube distal from the depth adjuster.

24. The tool of claim 1, wherein the bushing secures the guide tube in a retracted position.

25. The tool of claim 1, wherein the tool has a centralized center of gravity.

26. The tool of claim 1, further comprising a finger grip coupled to an end of the guide tube distal from the depth adjuster, wherein the finger grip is capable of receiving at least one detachable tool accessory.

27. The tool of claim 26, further comprising a protective tip attached to the finger grip.
